(19) United States
(12) Patent Application Publication
(10) Pub. No.: US 2002/0129156 A1
(43) Pub. Date: Sep. 12, 2002

(54) Plural media data synchronizing system

(76) Inventor: Masato Yoshikawa, Minato-ku (JP)

Correspondence Address: DICKSTEIN SHAPIRO MORIN & OSHINSKY LLP, 1177 Avenue of the Americas, New York, NY, 10036-2714, US

(21) Appl. No.: 10/067,325

(22) Filed: Feb. 7, 2002

(30) Foreign Application Priority Data
Feb. 7, 2001 (JP) 30318/2001

(51) Int. Cl. G06F 15/16; H04N 5/445; G06F 3/00; G06F 13/00

(52) U.S. Cl. 709/231; 725/37; 709/248

(57) ABSTRACT

A plural media data synchronizing system displays an image source connecting to data on a network. The system inserts into the image source an image marking including information used to display the data on the network. The image source is then divided and edited to produce image contents. When the image contents are reproduced, the image marking is retrieved from the image contents and a location where the data on the network are stored is detected. Then, the data on the network are retrieved via the network using the location and the retrieved data are displayed synchronizing with displaying of the image source based on a synchronizing timing of the image source.

### BACKGROUND OF THE INVENTION

1. Field of the Invention

The invention relates to a plural media data synchronizing system and a method of synchronizing plural media data and, in particular, to a system and a method which edit and integrate data provided via television broadcasting, image data provided through the Internet, and data stored in a package medium such as a DVD (Digital Versatile Disc).

2. Description of the Related Art

In a conventional plural media data synchronizing system, cue data are used for synchronization. First, the cue data including information for synchronization with a television program are created at a television station. Then, the cue data are received at a service provider and contents data are produced based on the cue data. After that, when the television program is broadcast and displayed on a TV, images in the contents data are displayed on the TV in predetermined timings, synchronizing with the television program.

Such the system is disclosed in Japanese Laid Open Publications Nos. H10-285460, H9-247599, and 2000-59724, and PCT No. PCT/US97/07493 (H11-510978).

However, in such the conventional systems, it is difficult to modify image data and add new information to the image data, once the image data are created and distributed. Alternatively, image data are not spread in an interactive (bi-directional) manner, although an interactive function is provided through a DVD to an extent.

This is because, in general, it is not easy to produce the image data. A digital broadcasting service using a BS (Broadcasting Satellite), which is recently started in Japan, provides with a television program in an interactive manner, but it is not considered that the television program is combined to other media and that similar interactive manner is still provided even if a user edit image data of the television program.

For example, according to a technique as described in a prior art document (H10-285460), a system providing television program related information is proposed. In the system, a client for providing television program related information is prepared at a receiving side and the client can display web contents synchronizing with a television program without a dedicated hardware circuit.

However, in the system, once the television program is recorded and the recorded television program is further edited, it is not possible to synchronize the web contents with the recorded television program except that information related to controlling synchronization is modified according to the edition of the recorded program.

In addition, since synchronization between the television program and the web contents is performed based on a strictly adjusted reproducing start time, it is not possible to synchronize the both when a broadcasting time of the television program is changed due to, for example, insertion of a sudden special program.

### SUMMARY OF THE INVENTION

Therefore, it is an object of the invention to provide a system and a method which connects a plurality of media, and provides the connection in a common interactive manner which is unchanged even if a combination of the media is changed or a user edits one of the media.

According to a first aspect of the invention, there is provided a plural media data synchronizing system which synchronizes image source with network data obtained from a network. The system comprises (a) an inserting unit which inserts into the image source an image marking including information used to display the network data synchronizing with the image source, (b) an image supplying unit which supplies the image source in which the image marking is inserted by the inserting unit, via a predetermined medium, (c) an editing/integrating unit which receives the image source from the image supplying unit and performs at least one of editing of the received image source and integrating of the received image source, to produce image contents, and (d) a display unit which detects the image marking from the image contents, and displays the image contents and the, network data synchronously based on synchronizing information obtained from the detected image marking.

According to a second aspect of the invention, there is provided a method of connecting an image source to network data obtained from a network, using a computer. The method comprises the steps of (a) inserting into the image source an image marking including information used to display the network data synchronizing with the image source, (b) supplying the image source in which the image marking is inserted in the inserting step, via a predetermined medium, (c) receiving the image source supplied by the supplying step as a received image source, (d) performing at least one of editing of the received image source and integrating of the received image source, to produce image contents, (e) detecting the image marking from the image contents as detected image marking, and (f) displaying the image contents and the network data synchronously based on synchronizing information obtained from the detected image marking.

According to a third aspect of the invention, there is provided a recording medium readable by a computer, tangibly embodying a program of instructions executable by the computer to perform a method of connecting an image source to network data obtained from a network. The method comprises the steps of (a) inserting into the image source an image marking including information used to display the network data synchronizing with the image source, (b) supplying the image source in which the image marking is inserted in the inserting step, via a predetermined medium, (c) receiving the image source supplied by the supplying step as a received image source, (d) performing at least one of editing of the received image source and integrating of the received image source, to produce image contents, (e) detecting the image marking from the image contents as detected image marking, and (f) displaying the image contents and the network data synchronously based on synchronizing information obtained from the detected image marking.

According to a fourth aspect of the invention, there is provided a computer data signal embodied in a carrier wave and representing a sequence of instructions which, when executed by a processor, cause the processor to perform a method of connecting an image source to network data obtained from a network. The method comprises the steps of (a) inserting into the image source an image marking including information used to display network data synchronizing with the image source, (b) supplying the image source in which the image marking is inserted in the inserting step, via a predetermined medium, (c) receiving the image source supplied by the supplying step as a received image source, (d) performing at least one of editing of the received image source and integrating of the received image source, to produce image contents, (e) detecting the image marking from the image contents as detected image marking, and (f) displaying the image contents and the network data synchronously based on synchronizing information obtained from the detected image marking.

According to a fifth aspect of the invention, there is provided a program product comprising, computer readable instructions and a recording medium bearing the computer readable instructions, the instructions being adaptable to enable a computer to perform a method of connecting an image source to network data obtained from a network. The method comprises the steps of (a) inserting into the image source an image marking including information used to display the network data synchronizing with the image source, (b) supplying the image source in which the image marking is inserted in the inserting step, via a predetermined medium, (c) receiving the image source supplied by the supplying step as a received image source, (d) performing at least one of editing of the received image source and integrating of the received image source, to produce image contents, (e) detecting the image marking from the image contents as detected image marking, and (f) displaying the image contents and the network data synchronously based on synchronizing information obtained from the detected image marking.

### BRIEF DESCRIPTION OF THE DRAWINGS

FIG. 1 shows a block diagram of a conventional plural media data synchronizing system;

FIG. 2 shows a block diagram of a plural media data synchronizing system according to a first embodiment of the invention;

FIG. 3 shows a diagram representing a configuration of an authoring system 101 shown in FIG. 2;

FIG. 4 shows a diagram representing an operation of an editing unit 104 shown in FIG. 2;

FIG. 5 shows a diagram representing an operation flow until synchronization between an edited image data and web contents is performed;

FIG. 6 shows a flowchart of an operation of a first embodiment of the invention;

FIG. 7 shows a block diagram of a second embodiment of the invention; and

FIG. 8 shows a block diagram of a third embodiment of the invention.

### DESCRIPTION OF THE PREFERRED EMBODIMENT

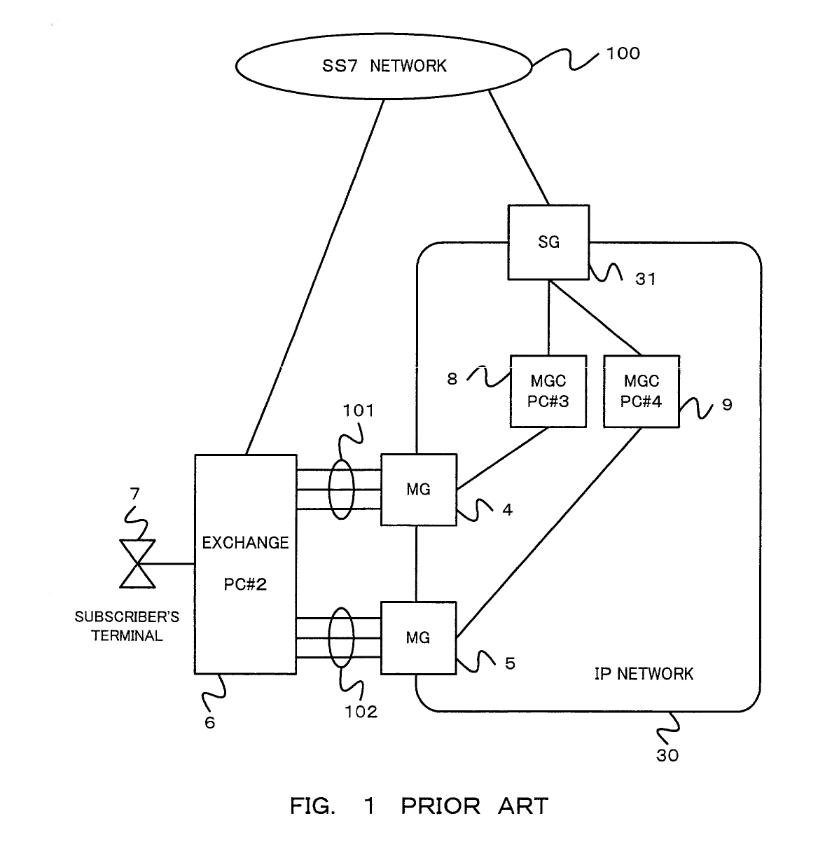

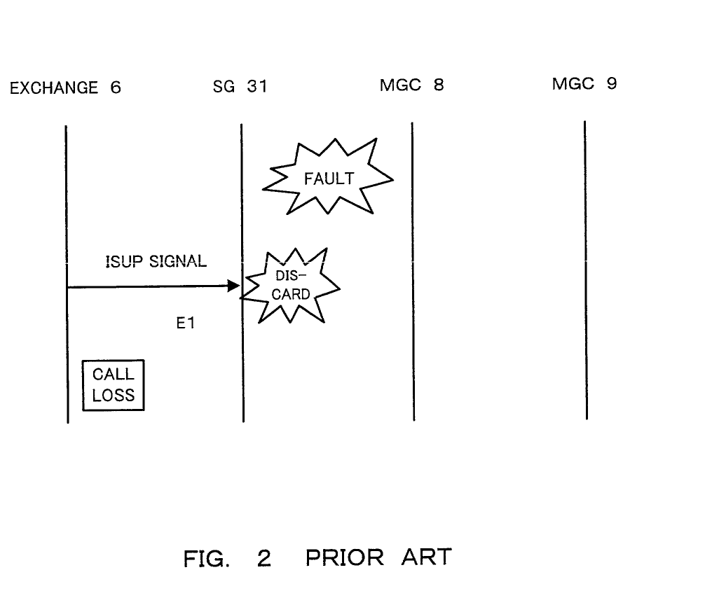

First, description is made about an example of a conventional plural media data synchronizing system disclosed in Japanese Laid Open Publication No. H10-285460, with reference to FIG. 1.

At a television (TV) station 601, cue data 607 are produced as synchronizing information by using a broadcast program 605. The broadcast program 605 is produced from a produced (television) program 602 and advertising information (CM) 603. The cue data 607 are then sent to a service provider 615.

At the service provider 615, timing information used to synchronize web contents 617 with the broadcast program 605, is produced by an authoring tool 616 and stored into contents 618.

When, at the television station 601, broadcasting of the broadcast program 605 is commenced by a broadcast system 606, the broadcast program 605 is received by a receiving equipment 609 in a family site (domestic site) 608 and sent to a television (TV) set 610.

Then, a tuner 611 in the television set 610 sends the broadcast program 605 to an image circuit 613 and the circuit 613 display the broadcast program on a cathode-ray tube 614.

Simultaneously, a receiving device 619 in the family site 608 receives the contents 618 via the Internet, and a client software 620 receives synchronizing information from the contents 618 and adjusts an internal clock 622.

When the internal clock 622 notifies that a synchronizing timing comes, the client software 620 displays the contents 618 on a browser 621. Thus, synchronization between image data and web contents is performed.

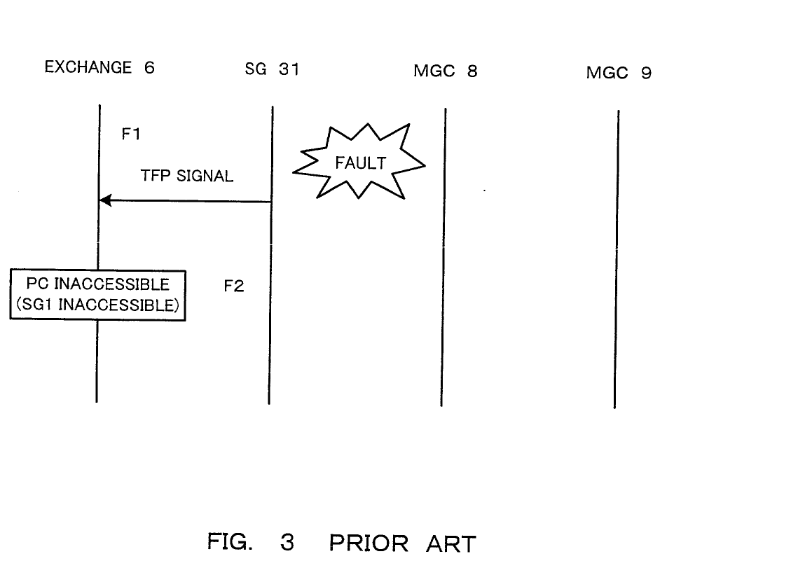

Next, description is made about a plural media data synchronizing system according to a first embodiment of the invention with reference to FIG. 2. In FIG. 2, the best mode of embodiments of the invention is shown.

The plural media data synchronizing system receives, for example, three kinds of data (media), that is, data of a broadcast television program, data provided via the Internet, and data from a package medium such as a DVD. Further, the system can connect the above three kinds of data in a common interactive manner which is maintained even if the data are modified of rearranged.

The system includes an authoring system 101, an image supplying unit 120, a user's personal computer 113 (hereinafter, which is referred to as “PC”), and a feature file library 102.

The authoring system 101 produces a feature file used for moving picture matching (time-varying image matching) based on an image source 100, and stores the feature file into the feature file library 102. The authoring system 101 further inserts an image marking (mark) representing a URL (Uniform Resource Locator) and a feature file ID (Identification) to create a mark-inserted image source 103. The mark-inserted image source 103 is provided to the general public (an audience) in a form of broadcasting data of a television program, data via the Internet, or data from a package medium.

The source 103 is then accumulated in the user's PC 113 and divided into, for example, image clips 105, 106, 107, which are used under a user environment by an editing unit 104 as materials for editing.

After a user voluntarily edits and integrates the materials (image clips), the edited and integrated materials are stored as image contents 108.

When the edited and integrated image contents 108 are supplied to an audience, an image marking identifying unit 109 detects the URL and the feature file ID included in the image marking which is inserted to the image source by the authoring system 101. Then, the image marking identifying unit 109 connects a web page storing a feature file which is used for moving picture matching and is designated by the feature file ID through, for example, the Internet. And next, the unit 109 retrieves the feature file and a synchronizing information script which corresponds to an image clip, from the feature file library 102.

The synchronizing information script includes information showing when data (web contents) are displayed. Also, the feature file is used to control to display the information. A moving picture matching time axis detecting unit 110 retrieves web contents (HTML (Hyper Text Markup Language) contents) 111 to be required to realize synchronization, from the retrieved feature file and the synchronizing information script. Then a viewer system 112 displays the image contents 108 and the web contents 111 with linking to each other. Thereby, synchronization of the both contents is performed.

Next, description is made about the first embodiment of the invention in detail, with reference to FIG. 2.

Referring to FIG. 2, the user's PC 113 includes the editing unit 104, the image marking identifying unit 109, the moving picture matching time axis detecting unit 110, and the viewer system 112.

The authoring system 101 inserts an image marking (including URL and a feature file ID) into an image source 100. The system 101 further extracts the feature file used for moving picture matching, from the image source 100 and stores the feature file to the feature file library 102.

The image supplying unit 120 provides the mark-inserted image source 103 in a form of, for example, broadcast data of a television program, data via the Internet, or data from a package medium.

The user's PC 113 receives the image source 103 in a form of broadcast data of a television program, data via the Internet, or data from a package medium, and stores them into a storage device thereof or a storage medium (not shown). The image source 103 is then divided into image clips 105, 106, and 107 by the editing unit 104 as materials used for editing. After that, the image clips are edited and integrated by user's instructions.

When the image contents 108 which is divided, edited, and integrated by the user is reproduced, the image marking identifying unit 109 detects the image marking (including URL and a feature file ID) inserted by the authoring system 101, from the image source 103. Then, the unit 109 accesses a feature file library 102 and retrieves a feature file used for moving picture matching and a synchronizing information script from the feature file library 102, by using the URL and the feature file ID.

By referring to the feature file and the synchronizing information script, the moving picture matching time axis detecting unit 110 retrieves web contents 111 required to realize synchronization via the Internet. The viewer system 112 provides the image contents 108 to an audience by synchronizing with the web contents 111, that is, by linking images in the image contents 108 to contents (for example, images) in the web contents 111.

Next, description is made about an operation of the first embodiment of the invention, with reference to FIGS. 3 to 6.

First, by the authoring system 101, a feature file used for moving picture matching is produced based on an image source 100 including digital data, and an image marking is inserted into the image source 100.

Referring to FIG. 3, the authoring system 101 includes a feature file producing unit 200 and an image marking inserting unit 201. The feature file producing unit 200 produces a feature file used to synchronize the image source with web contents, from the image source 100. In the feature file, known codes such as MPEG7 (Moving Picture Expert Group 7) are included. MPEG7 is a multimedia descriptor code enabling search of multimedia data (including audio data and visual data).

MPEG7 is developed to realize high-speed search of multimedia data, and standardizes a specification of a description about a keyword used in searching audio and visual information.

Since the feature file stores features of the image source 100 by using descriptors according to MPEG7, even if the image source 100 is edited, it is possible to search a specific location (for example, a time point) of images in the image source 100 by using the feature file.

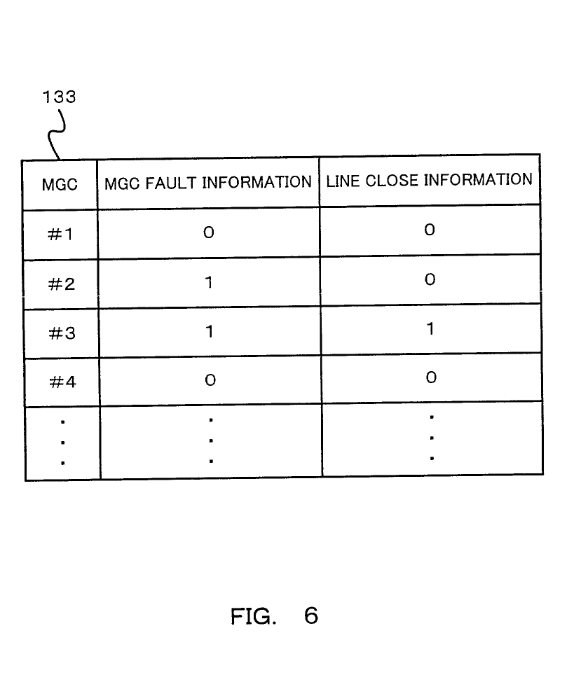

Furthermore, a synchronizing information script is made as well as the feature file. Therefore, even if images in the image source 100 are extracted and edited, it is not required to revise the synchronizing information script since features of images still remain in the feature file. When the feature file is created, the feature file is located into the feature file library 102 (step S1 in FIG. 6).

The feature file library 102 can be placed in a web server of a contents provider releasing the image source 100. And, an audience of the contents can access the feature file by designating a URL and referring to a feature file ID through the Internet.

After this accessing process, the image marking inserting unit 201 inserts a storing location of the feature file into the image source 100 as an image marking (step S2 of FIG. 6). The storing location includes a URL of the feature file library 102 and a feature file ID of the feature file. Also, the image marking can be utilized to protect the image source 100. The image marking can maintain copyright information of data in the image source 100, even if the image source 100 is edited.

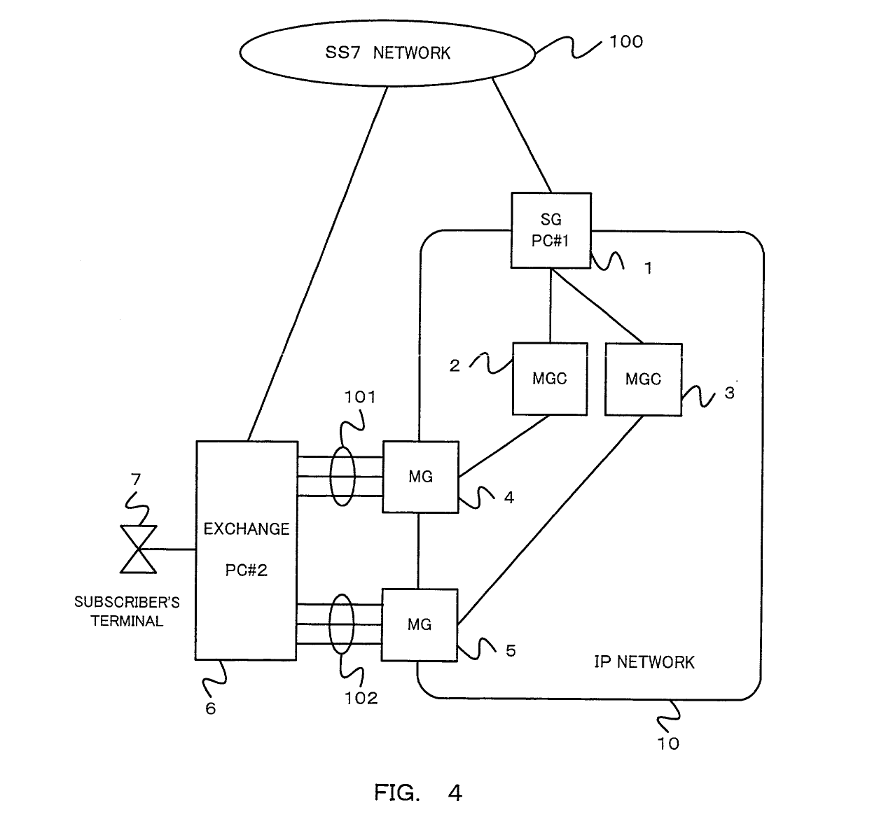

In FIG. 4, mark-inserted image sources 300 to 302 which are produced by the above image marking process of FIG. 3, are supplied to a user in a form of broadcast data of a television program 303, data provided via the Internet 304, or data from a package medium 305 (step S3 in FIG. 6). These image sources 300 to 302 can be edited so as to, for example, effectively utilize for education, presentation, or personal use by the editing unit 104 (step S4 in FIG. 6)

That is, the user can freely produce the image contents 108 by partly extracting a plurality of image clips 105 to 107 from the image sources 300 to 302. In the produced image contents 108, each image clip may not be located in the original location order or extracting order. However, since each clip is stored in the image contents 108 with information including image feature based on MPEG7, searching of an image clip can be performed by using the information.

Returning to FIG. 2, an image marking is inserted into each image source and information of the image marking is took over the corresponding image clip. Therefore, the image contents 108 produced by the editing and integrating of the plurality of image clips include the information of the image marking for each image clip.

The image marking identifying unit 109 extracts, for each part corresponding an image clip, a URL included in the information of the image marking from the image contents 108 and by using the URL, accesses the feature file library 102 via the Internet (step S5 in FIG. 6). Next, the unit 109 retrieves a feature file (used for moving picture matching) and a synchronizing information script each of which corresponds to an edited image, from the feature file library 102 by using a feature file ID (step S6 in FIG. 6).

Then, the moving picture matching time axis detecting unit 110 extracts a synchronizing time and synchronizing contents information by using the feature file and the synchronizing information script (step S6 in FIG. 6).

When the viewer system 112 starts to reproduce the edited image contents 108, the system 112 displays web contents relating with displaying of the image contents 108 based on a synchronizing timing (step S8 in FIG. 6).

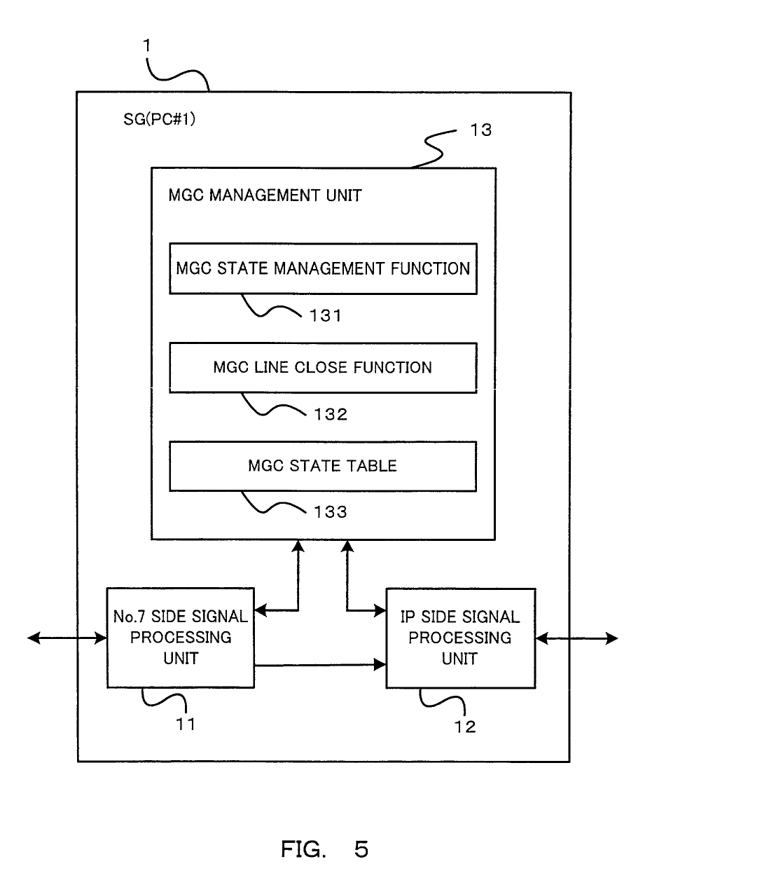

Next, in FIG. 5, image contents 701 are stored in a user's PC 700, and the image contents 701 include an image clip (1) which is a part of broadcast data of a television program, an image clip (2) which is a part of data provided via the Internet, and an image clip (3) which is a part of data from a package medium.

In the PC 700, a URL of a feature file library and a feature file ID are detected for each image clip, and then, the PC connects to each feature file library 703 which is placed outside of a family site where the PC 700 is located, via the Internet (information detection 702).

When the PC 700 is connected to one of feature files in the feature file libraries 703, by using each feature file ID, a feature file plus a synchronizing information script (1), a feature file plus a synchronizing information script (2), and a feature file plus a synchronizing information script (3) are selected, and the information is downloaded to the PC 700.

After the PC 700 retrieves the feature files and the synchronizing information scripts, when the user starts the viewer system 704, web contents information used to realize synchronization is identified by using the retrieved feature files and the retrieved synchronizing information scripts. Then, by using the identified web contents information, web contents 705 are retrieved via the Internet.

When a synchronizing timing comes, to synchronize the web contents 705 and each image clip of image data which are reproduced, the viewer system 704 displays the web contents 705 with synchronizing with displaying of image clips.

The viewer system display screen 706 includes an image display screen and a web contents display screen. For example, when the image display and the web contents display are performed in an operation system such as Windows (TM), the image display is reproduced on a dedicated image viewer screen of a viewer system and the web contents is displayed on a web browser such as Internet Explorer (TM) based on a synchronizing timing. Locations of the image display screen and the web contents display screen can be voluntary moved by the user.

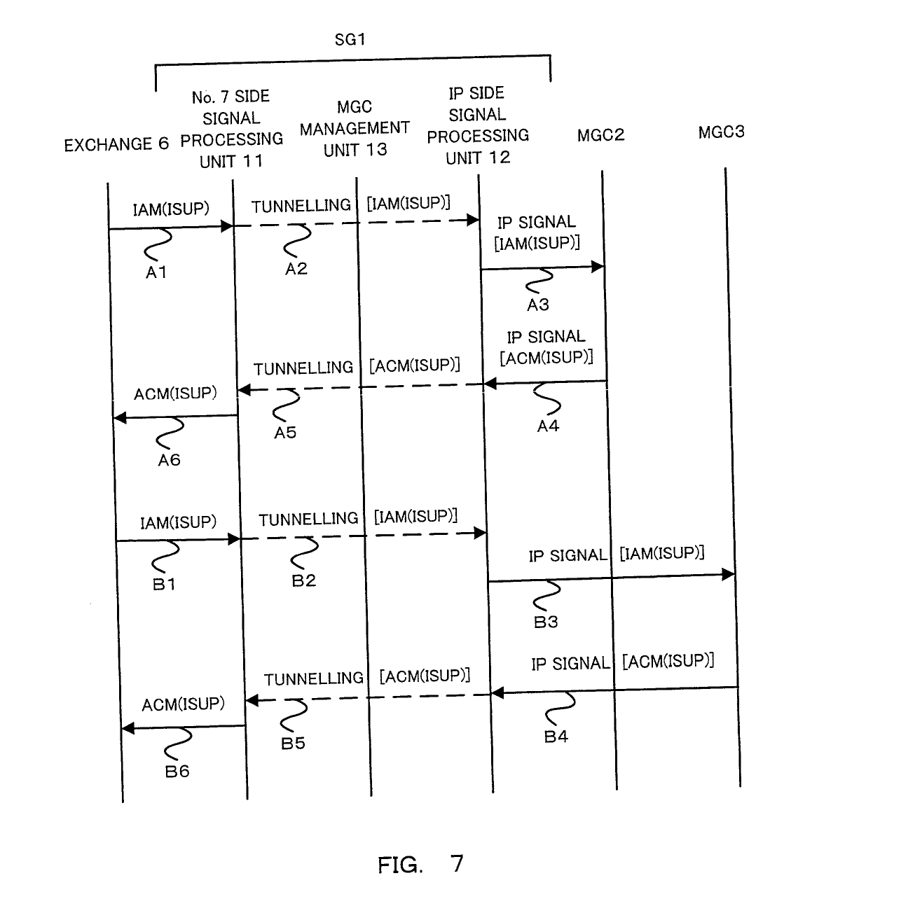

Next, description is made about a second embodiment of the invention, with reference to FIG. 7. As shown in FIG. 7, the second embodiment of the invention has no feature file library, unlike the first embodiment of the invention.

An image marking is inserted into an image source 400 by an authoring system 401. Herein, information about web contents is also inserted as the image marking. The information includes data used to access a web page based on a synchronizing timing of the image source 400, that is, includes moving picture matching information.

A mark-inserted image source 402 in which the image marking is inserted is supplied to a user's PC 411 in a form of broadcasting data of a television program, data via the Internet, or data from a package medium. In an editing unit 403 which is executed in the user's PC 411, the mark-inserted image source 402 is divided into a plurality of image clips 404 to 406 and then, the user produces image contents 407 by editing and integrating the image clips.

When the image contents 407 are reproduced at a viewer system 412, an image marking identifying unit 408 identifies a URL representing a location where the web contents 410 used in synchronization are stored, from the image marking which is inserted into the image contents 407. Then, a moving picture matching time axis detecting unit 409 retrieves the web contents (HTML contents) 410 via the Internet by using the identified URL. Subsequently, the viewer system 412 receives the web contents and displays the image contents 407 with linking to displaying of the web contents 410. Thereby, the image contents and the web contents are displayed synchronously.

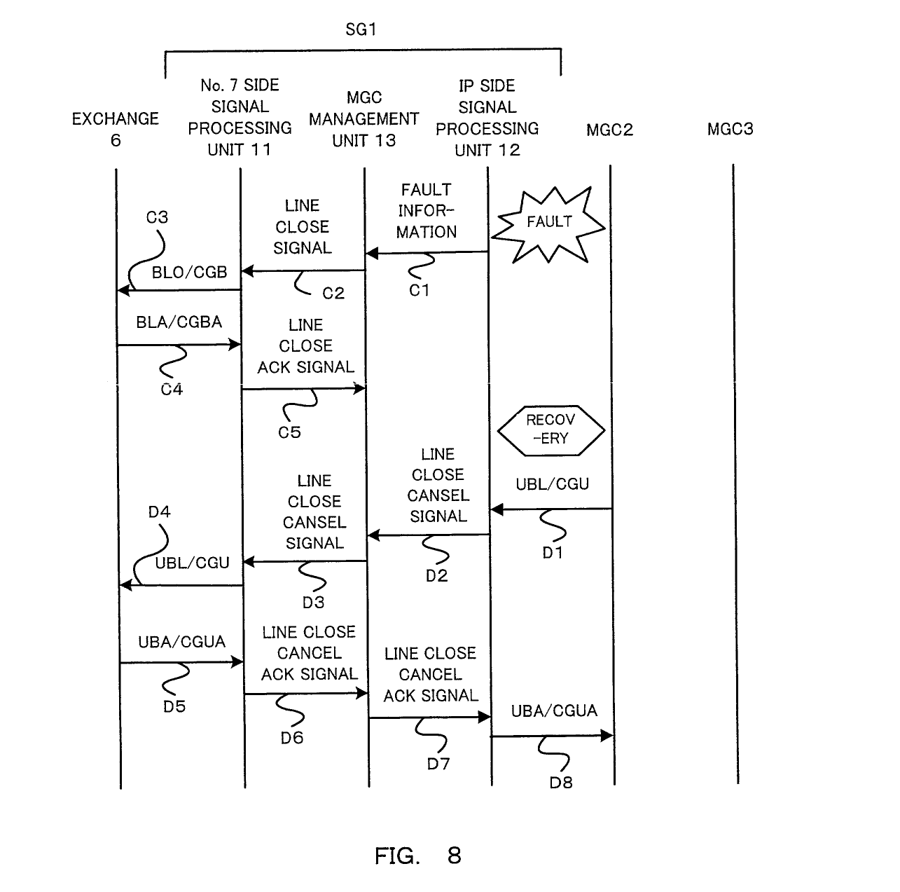

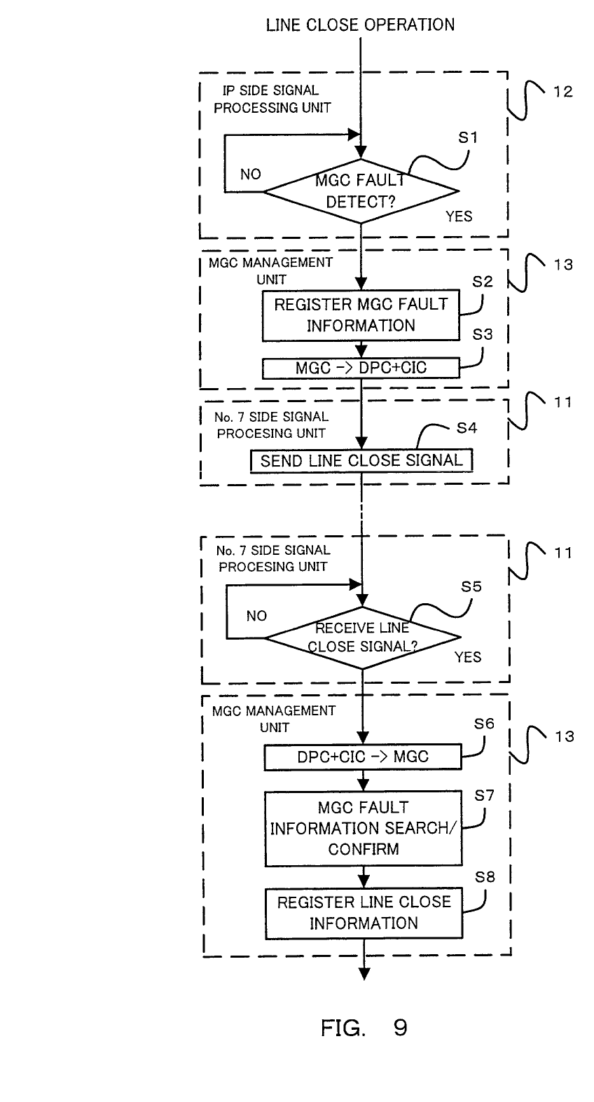

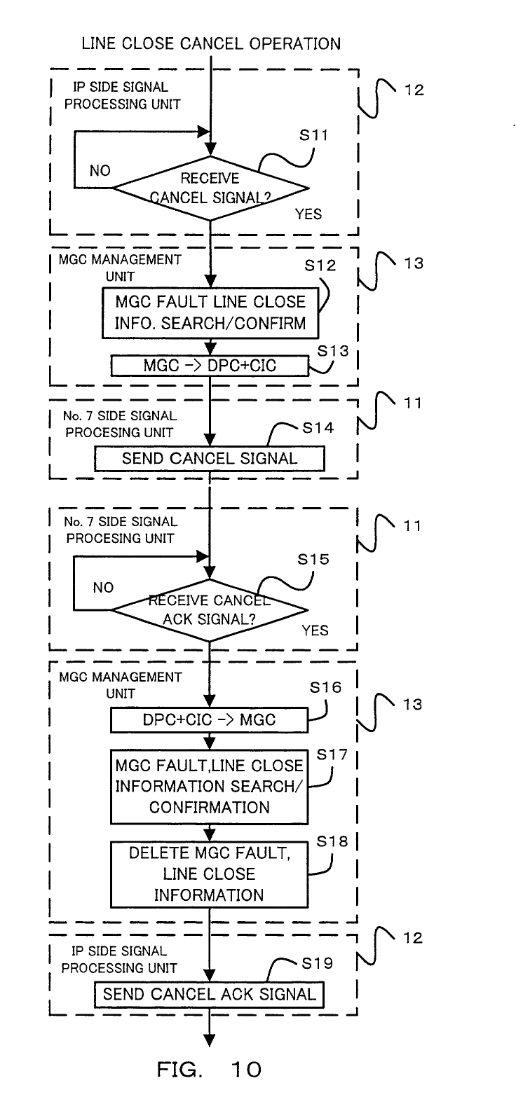

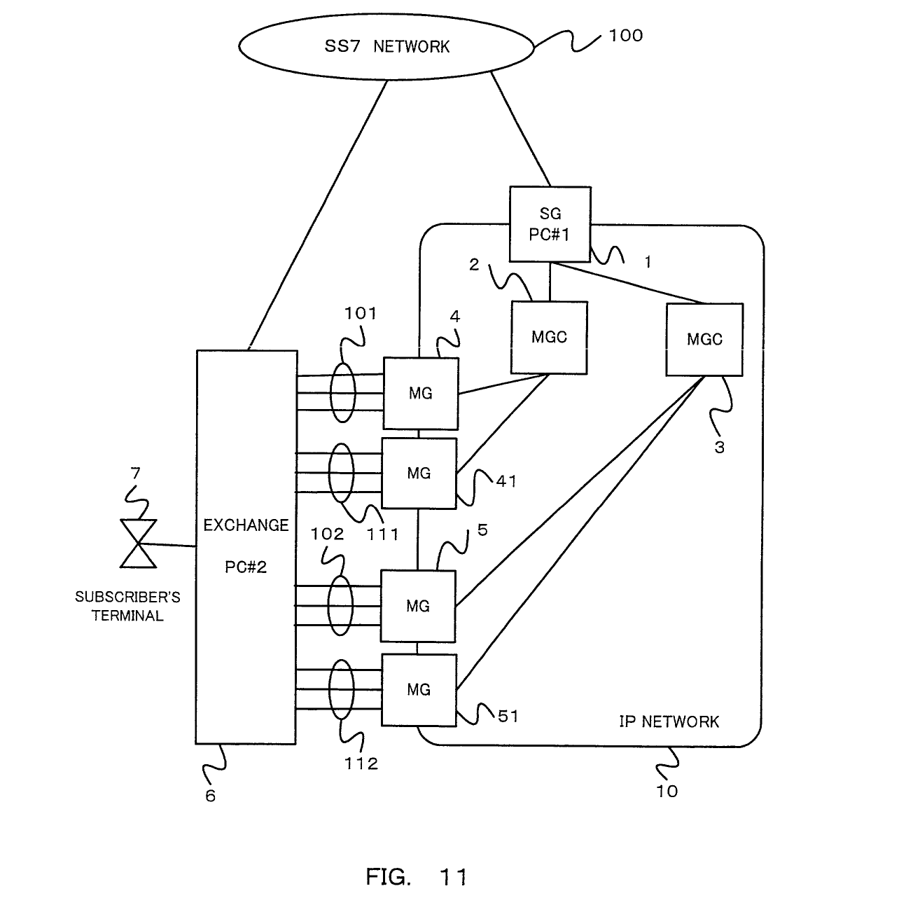

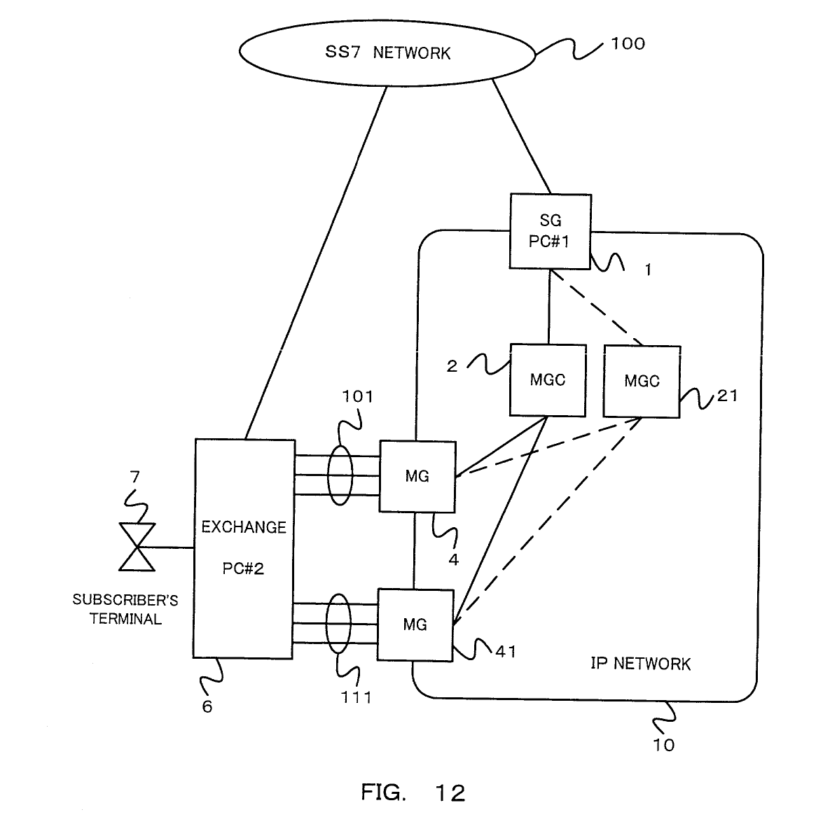

Next, description is made about a third embodiment of the invention, with reference to FIG. 8. Like the second embodiment, a plural media data synchronizing system according to the third embodiment has no feature file library. Further, in the system of the third embodiment, a mark-inserted image source is individually produced, in advance, for each data form, that is, broadcasting data of a television program, data via the Internet, and data from a package medium.

In FIG. 8, an authoring system 501 inserts an image marking into an image source 500. Herein, the image marking includes first information used to access a web page based on a synchronizing timing of the image source and second information used to identify web contents to be used.

A plurality of mark-inserted image sources 502 to 504 are supplied to a user's PC 511. The mark-inserted image source (1) 502 is supplied in a form of broadcasting data of a television program, the mark-inserted image source (2) 503 is supplied in a form of data via the Internet, and the mark-inserted image source (3) 504 is supplied in a form of data from a package medium.

Each of these image sources 502 to 504 is divided into a plurality of image clips, and edited and integrated to produce a sequence of image contents 506 by using an editing unit 505 executing on the user's PC 511.

There may be many other ways of editing and integrating images to produce the image contents. For example, the image contents are produced by editing images according to external editing procedure information, or by unrestrictedly editing images based on instructions from a user.

When the image contents 506 are reproduced at a viewer system 510, an image marking identifying unit 507 identifies a URL (the first information) representing a location where web contents 509 used in synchronization are stored, from the image marking which is inserted into the image contents 506. Then, a moving picture matching time axis detecting unit 508 retrieves the web contents (HTML contents) 509 via the Internet by using an identifying information (the second information). Subsequently, the viewer system 510 receives the web contents 509 and displays the image contents 506 with linking to displaying of the web contents 509. Thereby, the image contents and the web contents are displayed synchronously.

It is a first effectiveness of the invention to be able to modify and revise produced and spread image contents so as to have the newest contents.

It is a second effectiveness of the invention to be able to easily add an interactive function (bi-directional) to the image contents. According to the invention, it is capable of supplying an environment in which background information or the like related to image information can be easily accessed by combining images with web media which are most popular as interactive media.

It is a third effectiveness of the invention to be able to maintain the interactive function of the image contents and synchronized displaying of image contents, even if the image contents are edited by combining data from many different data sources such as broadcasting data, data via the Internet, and data from a package medium. According to the invention, since an image marking is inserted into the image data in the image contents, it is possible to retrieve information used to realize synchronization from the image data even if the image contents are edited.

What is claimed is:

1. A plural media data synchronizing system which connects image source to network data obtained from a network, comprising:
an inserting unit which inserts into the image source an image marking including information used to display the network data synchronizing with displaying of the image source;
an image supplying unit which supplies the image source in which the image marking is inserted by the inserting unit, via a predetermined medium;
an editing/integrating unit which receives the image source from the image supplying unit and performs at least one of editing of the received image source and integrating of the received image source, to produce image contents; and
a display unit which detects the image marking from the image contents, and displays the image contents and the network data synchronously based on synchronizing information obtained from the detected image marking.

2. The system of claim 1, wherein the image supplying unit supplies the image source by using a plurality of media.

3. The system of claim 1, wherein the inserting unit (a) produces a feature file used for moving picture matching based on the image source, (b) inserts the image marking including a description about a location where the feature file is stored, into the image source, and (c) produces a synchronizing information script showing when the network data are displayed.

4. The system of claim 3, wherein the editing/integrating unit performs at least one of the editing and the integrating by using the feature file and the synchronizing information script.

5. The system of claim 1, wherein the image marking includes information used to access the network data based on a synchronizing timing of the image source.

6. The system of claim 1, wherein the inserting unit inserts the image marking into the image source for each medium by which the image source is supplied.

7. The system of claim 6, wherein the image marking includes information used to access the network data based on a synchronizing timing of the image source, and information of the network data.

8. A method of connecting an image source to network data obtained from a network, using a computer, comprising the steps of:
inserting into the image source an image marking including information used to display the network data synchronizing with the image source;
supplying the image source in which the image marking is inserted in the inserting step, via a predetermined medium;
receiving the image source supplied by the supplying step as a received image source;
performing at least one of editing of the received image source and integrating of the received image source, to produce image contents;
detecting the image marking from the image contents as detected image marking; and
displaying the image contents and the network data synchronously based on synchronizing information obtained from the detected image marking.

9. The method of claim 8, wherein the supplying step supplies the image source by using a plurality of media.

10. The method of claim 8, wherein the inserting step (a) produces a feature file used for moving picture matching based on the image source, (b) inserts the image marking including a description about a location where the feature file is stored, into the image source, and (c) produces a synchronizing information script showing when the network data are displayed.

11. The method of claim 10, wherein the performing step performs at least one of the editing and the integrating by using the feature file and the synchronizing information script.

12. The method of claim 8, wherein the image marking includes information used to access the network data based on a synchronizing timing of the image source.

13. The method of claim 8, wherein the inserting step inserts the image marking into the image source for each medium by which the image source is supplied.

14. The method of claim 13, wherein the image marking includes information used to access the network data based on a synchronizing timing of the image source, and information of the data from the network.

15. A recording medium readable by a computer, tangibly embodying a program of instructions executable by the computer to perform a method of connecting an image source to network data obtained from a network, the method comprising the steps of:
inserting into the image source an image marking including information used to display the network data synchronizing with the image source;
supplying the image source in which the image marking is inserted in the inserting step, via a predetermined medium;
receiving the image source supplied by the supplying step as a received image source;
performing at least one of editing of the received image source and integrating of the received image source, to produce image contents;
detecting the image marking from the image contents as detected image marking; and
displaying the image contents and the network data synchronously based on synchronizing information obtained from the detected image marking.

16. A computer data signal embodied in a carrier wave and representing a sequence of instructions which, when executed by a processor, cause the processor to perform a method of connecting an image source to network data obtained from a network, the method comprising the steps of:
inserting into the image source an image marking including information used to display the network data synchronizing with the image source;
supplying the image source in which the image marking is inserted in the inserting step, via a predetermined medium;
receiving the image source supplied by the supplying step as a received image source;
performing at least one of editing of the received image source and integrating of the received image source, to produce image contents;
detecting the image marking from the image contents as detected image marking; and
displaying the image contents and the network data synchronously based on synchronizing information obtained from the detected image marking.

17. A program product comprising, computer readable instructions and a recording medium bearing the computer readable instructions, the instructions being adaptable to enable a computer to perform a method of connecting an image source to network data obtained from a network, the method comprising the steps of:
inserting into the image source an image marking including information used to display the network data synchronizing with the image source;
supplying the image source in which the image marking is inserted in the inserting step, via a predetermined medium;
receiving the image source supplied by the supplying step as a received image source;
performing at least one of editing of the received image source and integrating of the received image source, to produce image contents;
detecting the image marking from the image contents as detected image marking; and
displaying the image contents and the network data synchronously based on synchronizing information obtained from the detected image marking.
